(19) United States
(12) Patent Application Publication
(10) Pub. No.: US 2024/0240724 A1
(43) Pub. Date: Jul. 18, 2024

(54) AERATING BAG

(71) Applicant: TUNG CHENG CHEN, Taichung City (TW)

(72) Inventor: TUNG CHENG CHEN, Taichung City (TW)

(21) Appl. No.: 18/097,711

(22) Filed: Jan. 17, 2023

(51) Int. Cl. F16K 24/04

(52) U.S. Cl. CPC F16K 24/04

(57) ABSTRACT

An aerating bag has a body, a leaking device, and a unidirectional nozzle. The body is compressible and has an upper membrane, a lower membrane, an inflatable chamber, and an outlet. The upper membrane has a pressing segment, a mounting segment, and a concaved segment. The lower membrane is connected to the upper membrane. The inflatable chamber is formed in the pressing segment between rear ends of the upper membrane and the lower membrane and the concaved segment. The leaking device is connected to the body and has a leaking valve movably disposed in the mounting segment and abutted against an inclined wall. The unidirectional nozzle is mounted in the body between the two membranes, communicates with the inflatable chamber, selectively communicates with the outlet, and has a communicating recess, a ventilating duct, a covering board, and a valve slice.

### BACKGROUND OF THE INVENTION

### 1. Field of the Invention

The present invention relates to an aerating bag, and more particularly relates to an aerating bag that can improve the air inflation efficiency of the aerating bag, can improve airtightness of the aerating bag, and can reduce the cost of manufacturing the aerating bag.

### 2. Description of Related Art

With reference to FIGS. 10 and 11A, a conventional aerating bag is used to inflate objects such as sports protectors, and has an inflatable segment 70, a vent segment 80, and a unidirectional nozzle 90. The inflatable segment 70 is made of an elastic material such as rubber to store air, is extrudable and has an upper membrane 71, a lower membrane 72, and a concaved segment 73. The upper membrane 71 has a front end, a rear end, and a bottom. The lower membrane 72 is connected to the upper membrane 71 to form the closed inflatable 70 and has a top side and a bottom side. The top side of the lower membrane 72 is connected to the bottom of the upper membrane 71. The concaved segment 73 is formed in the upper membrane 71 between the front end and the rear end of the upper membrane 71, and faces the top side of the lower membrane 72 to form a gap between the upper membrane 71 and the lower membrane 72.

The vent segment 80 is formed on the front end of the upper membrane 71 of the inflatable segment 70, selectively communicates with the inflatable segment 70 and has an outlet 81 and a leaking valve 82. The outlet 81 is connected to the bottom side of the lower membrane 72 near the front end of the upper membrane 71 and is used to connect with an inflatable object. The leaking valve 82 is pressingly disposed on the front end of the upper membrane 71 to provide a deflating effect for the conventional aerating bag and has an abutting face 821 abutted against an internal wall of the upper membrane 71.

The unidirectional nozzle 90 is securely mounted in the gap between the concaved segment 73 and the lower membrane 72 at a middle of the concave segment 73 to facilitate the vent segment 80 to communicate with the inflatable segment 70 and has two valve slices 91, 92. The valve slices 91, 92 include an upper valve slice 91 and a lower valve slice 92. The lower valve slice 91 is mounted between and abuts the upper valve slice 91 and the top side of the lower membrane 72. Each one of the valve slices 91, 92 has a shape, an outer periphery, a front end, and a rear end. The shapes of the valve slices 91, 92 are the same, the front ends of the valve slices 91, 92 extend into the vent segment 80, and the rear ends of the valve slices 91, 92 extend into the inflatable segment 70. Furthermore, the valve slices 91, 92 are overlapped with each other at the middle of the concave segment 73 such that the outer periphery of the upper valve slice 91 aligns with the outer periphery of the lower valve slice 92.

In use, with reference to FIGS. 11A and 11B, the two membranes 71, 72 of the inflatable segment 70 are respectively pressed by two fingers of a user to extrude the inflatable segment 70 to enable air that is stored in the inflatable segment 70 to flow into the vent segment 80 via the unidirectional nozzle 90. However, when the inflatable segment 70 is extruded by the user's fingers, the rear ends of the valve slices 91, 92 may be pressed with the deformation of the two membranes 71, 72. Then, the rear ends of the valve slices 91, 92 cannot be open to enable air to flow into the vent segment 80, and this means the rear ends of the valve slices 91, 92 cannot be open to form an interval to enable air to flow into the vent segment 80 because the deformation of the two membranes 71, 72 of the inflatable segment 70. Therefore, air that is stored in the inflatable segment 70 cannot be successfully flowed into the vent segment 80 when the user presses and extrudes the inflatable segment 70, and this means the user needs to press and extrude the inflatable segment 70 of the conventional aerating bag many times to achieve an air inflation effect and this will significantly reduce the air inflation efficiency of the conventional aerating bag.

Furthermore, since the valve slices 91, 92 are overlapped with each other and the rear ends of the valve slices 91, 92 are needed to open when the inflatable segment 70 is pressed by the user, the precision requirements for manufacturing the valve slices 91, 92 are high and this will increase the cost of manufacturing the conventional aerating bag. Due to the high precision requirements for manufacturing the conventional aerating bag, the conventional aerating bag is not easy to manufacture and prone to failure when operating. In addition, the engagement between the abutting face 821 of the leaking valve 82 and the internal wall of the upper membrane 71 is planar contact and may air leak when the processing accuracy of the engagement between the abutting face 821 of the leaking valve 82 and the internal wall of the upper membrane 71 is not good.

Therefore, the present invention provides an aerating bag to mitigate or obviate the aforementioned problems.

### SUMMARY OF THE INVENTION

The main objective of the present invention is to provide an aerating bag that can improve the air inflation efficiency of the aerating bag, can improve airtightness of the aerating bag, and can reduce the cost of manufacturing the aerating bag.

The aerating bag in accordance with the present invention has a body, a leaking device, and a unidirectional nozzle. The body is compressible and has an upper membrane, a lower membrane, an inflatable chamber, and an outlet. The upper membrane has a pressing segment, a mounting segment, and a concaved segment. The lower membrane is connected to the upper membrane. The inflatable chamber is formed in the pressing segment between rear ends of the upper membrane and the lower membrane and the concaved segment. The leaking device is connected to the body and has a leaking valve movably disposed in the mounting segment and abutted against an inclined wall. The unidirectional nozzle is mounted in the body between the two membranes, communicates with the inflatable chamber, selectively communicates with the outlet, and has a communicating recess, a ventilating duct, a covering board, and a valve slice.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of an aerating bag in accordance with the present invention;

FIG. 2 is another perspective view of the aerating bag in FIG. 1;

FIG. 3 is a perspective view in partial section of the aerating bag in FIG. 1;

FIG. 4 is a side view of the aerating bag in FIG. 1;

FIG. 5 is an enlarged side view of the aerating bag in FIG. 4;

FIG. 6 is an inflatable-operational side view of the aerating bag in FIG. 1;

FIG. 7 is an enlarged inflatable-operational side view of the aerating bag in FIG. 6;

FIG. 8 is an enlarged discharging-operational side view of the aerating bag in FIG. 1;

FIG. 9 is an enlarged inflatable-operational side view of a second embodiment of an aerating bag in accordance with the present invention;

FIG. 10 is a bottom perspective view of an aerating bag in accordance with the prior art;

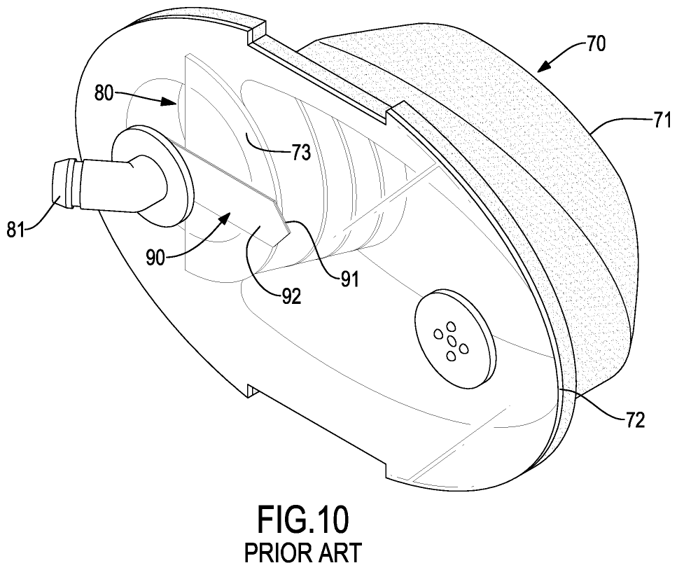

FIG. 11A is an inflatable-operational side view in partial section of the aerating bag in FIG. 10; and

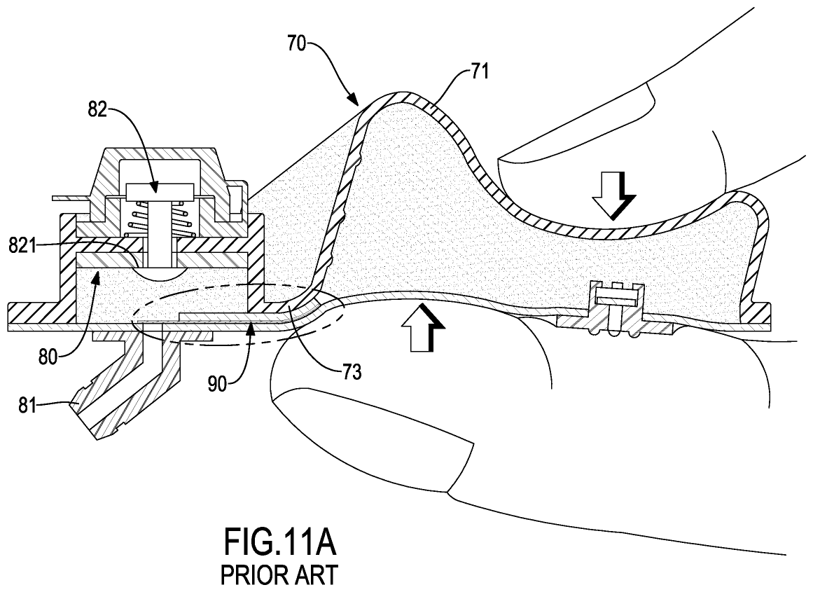

FIG. 11B is an enlarged inflatable-operational side view in partial section of the aerating bag in FIG. 11A.

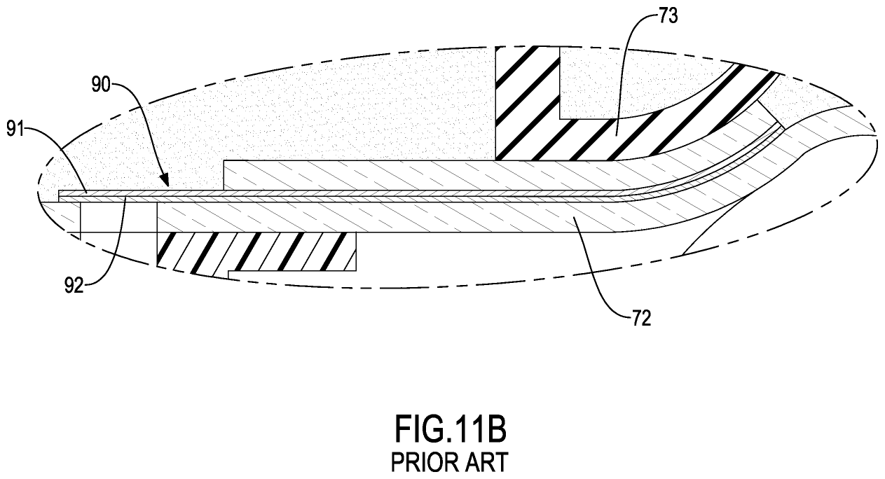

### DETAILED DESCRIPTION OF THE PREFERRED EMBODIMENT

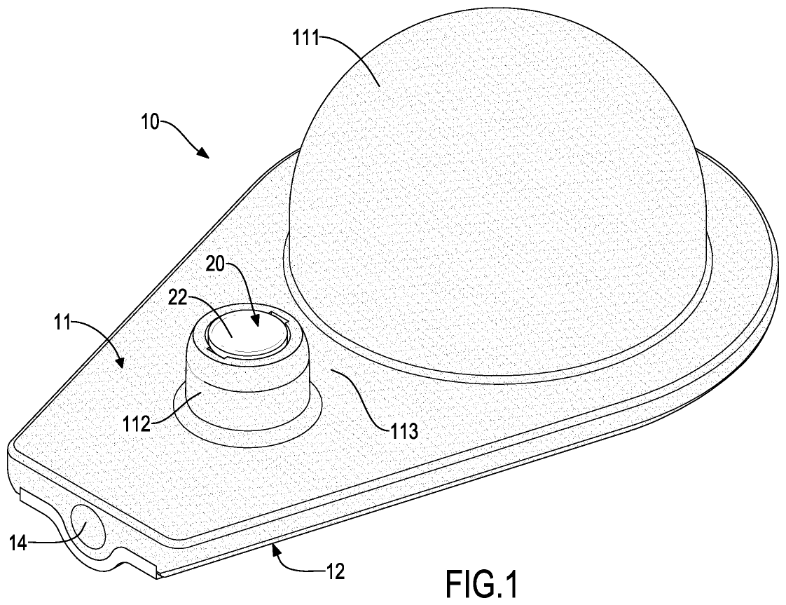

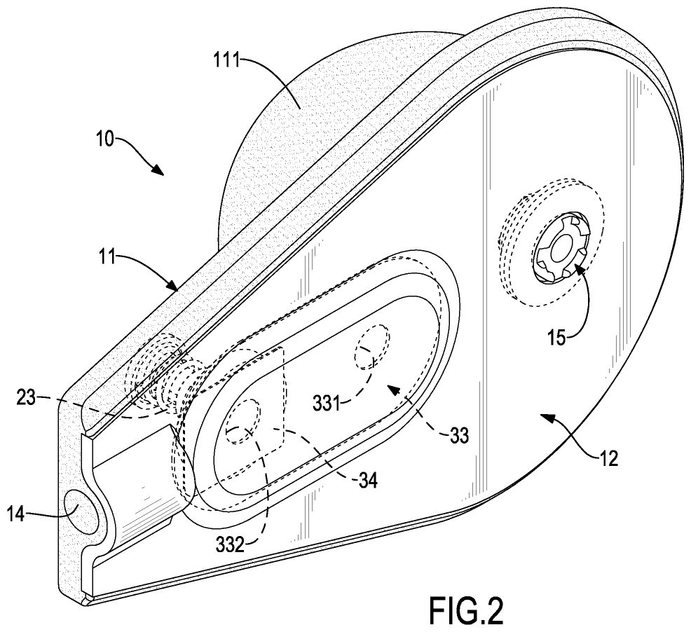

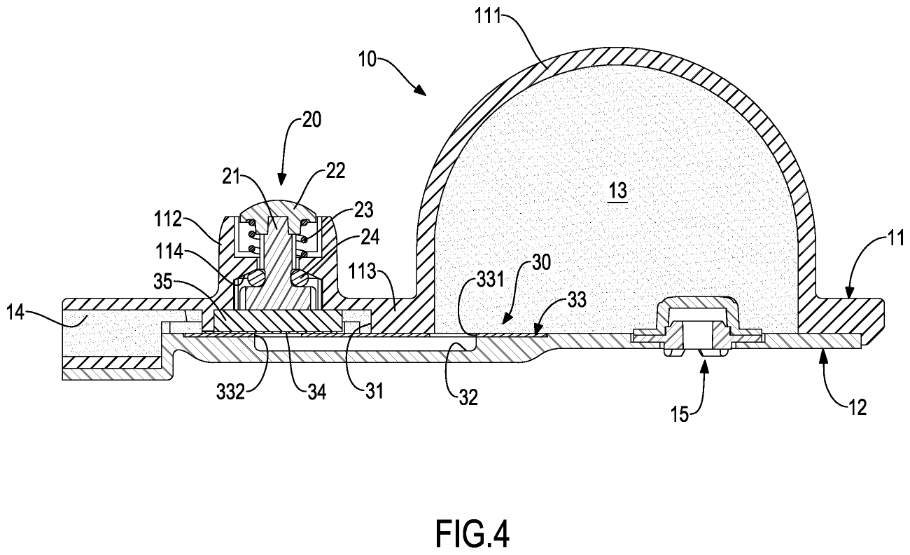

With reference to FIGS. 1 to 4, a first embodiment of an aerating bag in accordance with the present invention has a body 10, a leaking device 20, and a unidirectional nozzle 30.

The body 10 is compressible and has an upper membrane 11, a lower membrane 12, an inflatable chamber 13, an outlet 14, and a check valve 15. The upper membrane 11 may be made of an elastic material such as rubber, is compressible and has a front end, a rear end, a top side, a bottom side, an outer periphery, a pressing segment 111, a mounting segment 112, and a concaved segment 113. The pressing segment 111 may be hemispherical, is hollow and is formed on and protruded from the top side of the upper membrane 11 adjacent to the rear end of the upper membrane 11. The mounting segment 112 is formed on and protruded from the top side of the upper membrane 11 adjacent to the front end of the upper membrane 11 and has an inclined wall 114. The inclined wall 114 is annularly formed on an internal surface of the mounting segment 112. The concaved segment 113 is formed in the upper membrane 11 between the pressing segment 111 and the mounting segment 112 of the upper membrane 11 and has a bottom face.

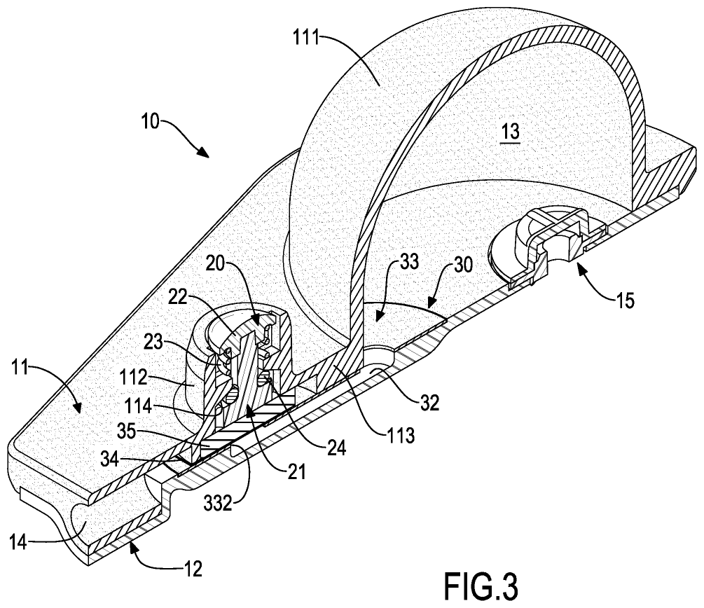

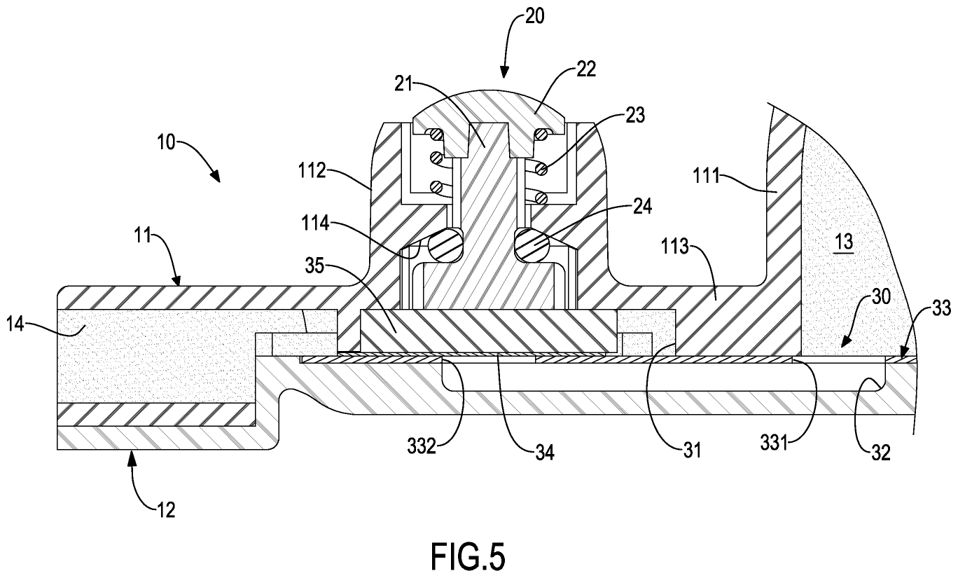

The lower membrane 12 may be made of plastic, is connected to the upper membrane 11 to form the closed body 10 and has a front end, a rear end, a top side, a bottom side, and an outer periphery. With reference to FIGS. 3 and 5, the top side of the lower membrane 12 at the outer periphery of the lower membrane 12 is securely connected to the bottom side of the upper membrane 11 at the outer periphery of the upper membrane 11 such that the bottom face of the concaved segment 113 to face the top side of the lower membrane 12.

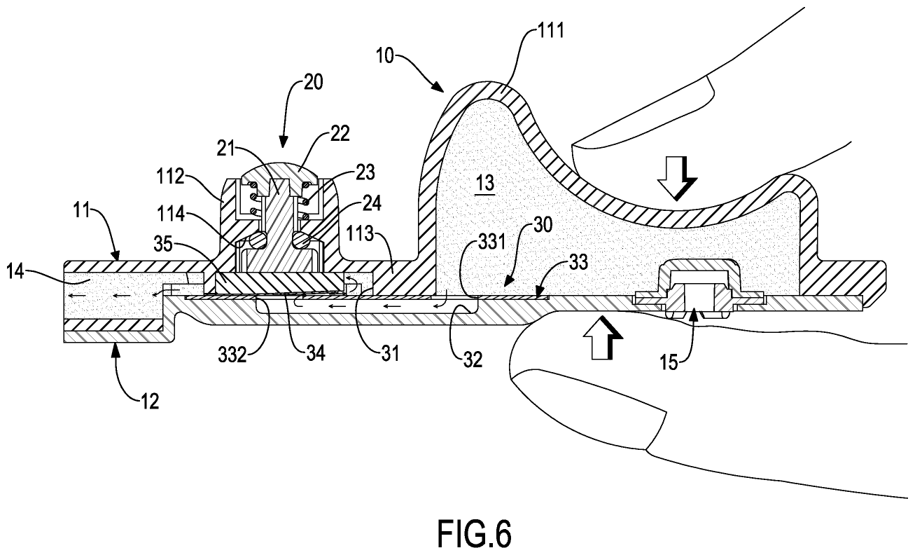

The inflatable chamber 13 is formed in the body 10, is formed in the pressing segment 111 between the rear ends of the upper membrane 11 and the lower membrane 12 and the concaved segment 113 to store air, and selectively communicates with the mounting segment 112 of the upper membrane 11. The outlet 14 is transversally formed in the front end of the upper membrane 11 and selectively communicates with the inflatable chamber 13 via the mounting segment 112 of the upper membrane 11. The check valve 15 is securely mounted on the bottom side of the lower membrane 12 near the rear end of the lower membrane 12, and extends into and communicates with the inflatable chamber 13. With reference to FIG. 6, when the inflatable chamber 13 is extruded by a user's fingers pressing the two membranes 11, 12, the air in the inflatable chamber 13 will not flow out of the inflatable chamber 13 via the check valve 15. In addition, the inflatable chamber 13 is set in the vacuum state after the user's fingers press the two membranes 11, 12. When the user removes the fingers from the two membranes 11, 12 to enable the two membranes 11, 12 to return to the original positions, outside air will flow into the inflatable chamber 13 via the check valve 15. The check valve 15 is conventional and the features and the structures of the check valve 15 are not to be described in detail.

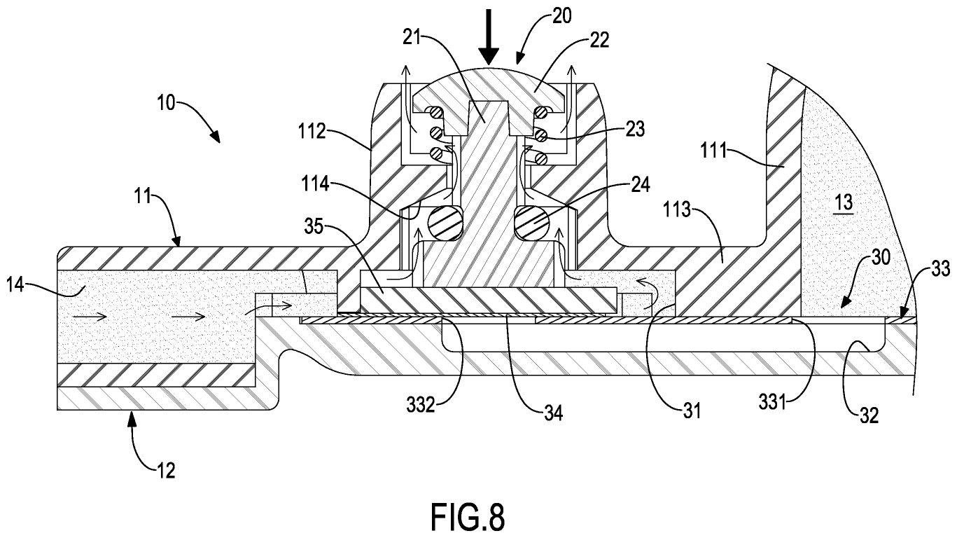

With reference to FIGS. 3 to 5, the leaking device 20 is connected to the body 10 and has a leaking valve 21, a pressing button 22, and an elastic element 23. The leaking valve 21 is movably disposed in the mounting segment 112 of the upper membrane 11, abuts against the inclined wall 114 of the mounting segment 112 and has an inner end, an outer end, and a sealing ring 24. The inner end of the leaking valve 21 is mounted in the mounting segment 112, extends through the inclined wall 114 and faces the top side of the lower membrane 12. The outer end of the leaking valve 21 extends out of the mounting segment 112. The sealing ring 24 is mounted around the leaking valve 21 between the inner end and the outer end of the leaking valve 21 and abuts against the inclined wall 114 of the mounting segment 112 to prevent air in the inflatable chamber 13 flowing out of the body 10 from the leaking device 20. In addition, since the inclined wall 114 is tapered from a direction along the bottom side to the top side of the upper membrane 11, this may increase a contact area between the inclined wall 114 and the sealing ring 24 to improve the airtightness of the aerating bag. Furthermore, with reference to FIG. 8, when the outlet 14 is connected to an inflatable object, a user may press the leaking device 20 to move the leaking valve 21 downwardly relative to the mounting segment 112, and the sealing ring 24 is separated from the inclined wall 114 of the mounting segment 112 to form a gap, and air in the inflatable object will flow out of the inflatable object via the outlet 14 and the gap.

The pressing button 22 is connected to the outer end of the leaking valve 21 and is disposed out of the mounting segment 112 of the upper membrane 11. The user may press the pressing button 22 to move the leaking valve 21 relative to the mounting segment 112 of the upper membrane 11. The elastic element 23 is mounted around the leaking valve 21 between the inclined wall 114 and the pressing button 22 to enable the sealing ring 24 to abut against the inclined wall 114 to provide an airtight effect to the aerating bag.

With reference to FIGS. 3 to 5, the unidirectional nozzle 30 is mounted in the body 10 between the upper membrane 11 and the lower membrane 12, communicates with the inflatable chamber 13, selectively communicates with the outlet 14, and has a communicating recess 31, a ventilating duct 32, a covering board 33, a valve slice 34, and a holding mount 35. The communicating recess 31 is formed in the body 10 between the mounting segment 112 of the upper membrane 11 and the top side of the lower membrane 12, between the outlet 14 and the concaved segment 113 of the upper membrane 11, communicates with the outlet 14, and selectively communicates with the inflatable chamber 13 of the body 10. The ventilating duct 32 is elongated, is formed in the top side of the lower membrane 12, communicates with the inflatable chamber 13, and selectively communicates with the communicating recess 31.

The covering board 33 is securely mounted on the top side of the lower membrane 12 to cover the ventilating duct 32, extends into the inflatable chamber 13, extends toward the outlet 14, and has an inlet hole 331 and an outlet hole 332. The inlet hole 331 is formed through the covering board 33 and communicates with the inflatable chamber 13 and the ventilating duct 32. Then the ventilating duct 32 communicates with the inflatable chamber 13 via the inlet hole 331. The outlet hole 332 is formed through the covering board 33, is disposed below the communicating recess 31, and communicates with the ventilating duct 32. With reference to FIG. 5, the valve slice 34 is disposed in the communicating recess 31, is mounted on the covering board 33 to selectively cover the outlet hole 332 of the covering board 33, and has a fixed edge and a free edge. The fixed edge of the valve slice 34 is securely connected to the covering board 33 adjacent to the outlet 14. The free edge of the valve slice 34 extends across the outlet hole 332 and movably abuts the covering board 33. The holding mount 35 is made of soft material, is mounted in the communicating recess 31 and abuts the valve slice 34.

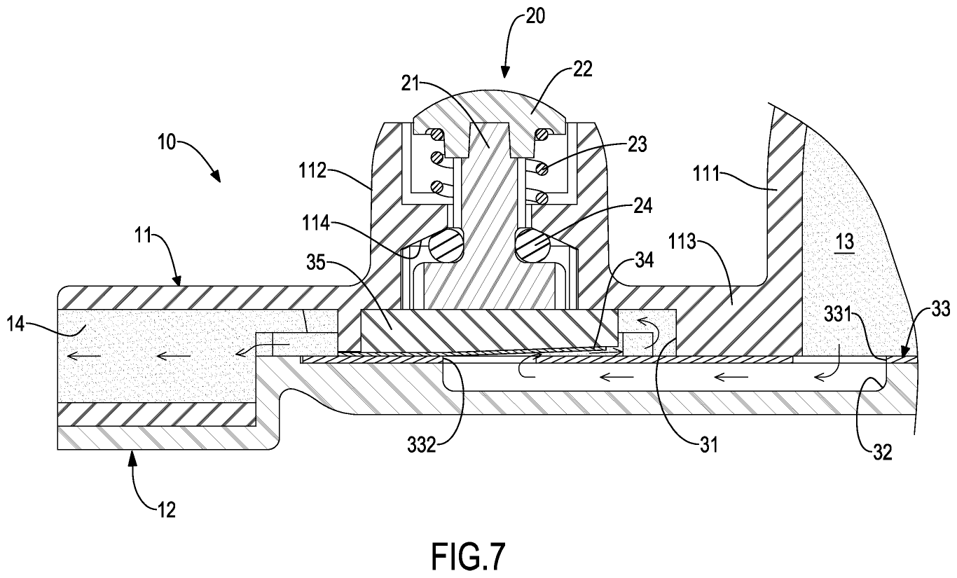

With reference to FIG. 6, when using the aerating bag in accordance with the present invention to fill air into an inflatable object, connecting the outlet 40 with the inflatable object and pressing the two membranes 11, 12 of the body 10 to let the air in the inflatable chamber 13 flow into the ventilating duct 32 via the inlet hole 331 of the covering board 33. At the same time, with reference to FIG. 7, the air flows in the ventilating duct 32 will push the valve slice 34 to move relative to the covering board 33 via the inlet hole 332. Then the free edge of the valve slice 34 is moved upwardly to separate from the covering board 33 and to form an interspace between the valve slice 34 and the covering board 33, and the air in the ventilating duct 32 can flow into the inflatable object via the inlet hole 332, the interspace, the communicating recess 31, and the outlet 14 easily. Furthermore, after the user's fingers press the two membranes 11, 12, the inflatable chamber 13 is set in the vacuum state and this can make the check valve 15 allow the outside air to flow into the inflatable chamber 13 when the user removes the fingers from the two membranes 11, 12. After the above-mentioned operating cycle, the inflatable object can be inflated completely and quickly.

With reference to FIG. 8, when the inflate inflatable object needs to be released, the user can press the pressing button 22 of the leaking device 20 downwardly to enable the leaking valve 21 to move relative to the mounting segment 112 to separate the sealing ring 24 from the inclined wall 114 of the mounting segment 112 to form a gap between the sealing ring 24 and the inclined wall 114. Then, the air in the inflatable object can be flowed out of the inflatable object via the outlet 14, the communicating recess 31, and the gap between the sealing ring 24 and the inclined wall 114 of the mounting segment 112.

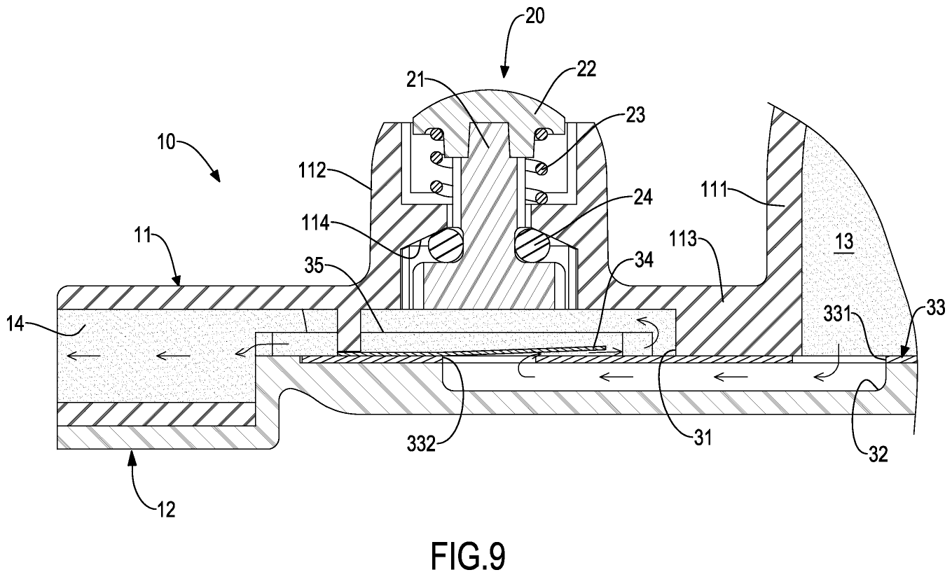

With reference to FIG. 9, a second embodiment of an aerating bag in accordance with the present invention has similar structures substantially the same as the structures in the above-mentioned first embodiment of the aerating bag except the following features. In the second embodiment of the present invention, the unidirectional nozzle 30 does not have a holding mount 35 disposed in the communicating recess 31, and air in the inflatable chamber 13 also can be flowed out of the outlet 14 via the inlet hole 331, the ventilating duct 32, the outlet hole 332, and the communicating recess 31.

According to the above-mentioned features and structural relationships of the aerating bag in accordance with the present invention, first, only a single valve slice 34 is used in the aerating bag, and this can avoid the interface between the two overlapped valve slices 91, 92, and the single valve slice 34 is disposed between the communicating recess 31 and the ventilating duct 32 rather than the concaved segment 113 and is not affected by the deformation of the two membranes 11, 12 that are pressed by a user. Consequently, the free edge of the valve slice 34 can be lifted accurately and surely when air flows into the ventilating duct 32, and this can improve the air inflation efficiency of the aerating bag to inflate an inflatable object easily and quickly. Furthermore, the precision requirements for manufacturing the single valve slice 34 is lower than those of the two valve slices 91, 92 and this will reduce the cost of manufacturing the aerating bag of the present invention. Due to the low precision requirements for manufacturing the aerating bag of the present invention, the aerating bag of the present invention is easy to manufacture and can be inflated successfully when operating. Second, the structures and engagement between the inclined wall 114 and the sealing ring 24 can increase the contact area to improve airtightness of the aerating bag during an inflating process of the aerating bag of the present invention. Therefore, the aerating bag of the present invention can improve the air inflation efficiency of the aerating bag, can improve airtightness of the aerating bag, and can reduce the cost of manufacturing the aerating bag.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An aerating bag comprising:
a body being compressible and having
an upper membrane having
a front end;
a rear end;
a top side;
a bottom side;
a pressing segment formed on and protruded from the top side of the upper membrane adjacent to the rear end of the upper membrane;
a mounting segment formed on and protruded from the top side of the upper membrane adjacent to the front end of the upper membrane and having an inclined wall annularly formed on an internal surface of the mounting segment; and
a concaved segment formed in the upper membrane between the pressing segment and the mounting segment of the upper membrane and having a bottom face;
a lower membrane connected to the upper membrane to form the body and having
a front end;
a rear end;
a top side of the lower membrane at an outer periphery of the lower membrane securely connected to the bottom side of the upper membrane at an outer periphery of the upper membrane such that the bottom face of the concaved segment faces the top side of the lower membrane; and
a bottom side;
an inflatable chamber formed in the body, formed in the pressing segment between the rear ends of the upper membrane and the lower membrane and the concaved segment to store air, and selectively communicating with the mounting segment of the upper membrane; and
an outlet transversally formed in the front end of the upper membrane and selectively communicating with the inflatable chamber via the mounting segment of the upper membrane;
a leaking device connected to the body and having a leaking valve movably disposed in the mounting segment of the upper membrane and abutted against the inclined wall of the mounting segment; and
a unidirectional nozzle mounted in the body between the upper membrane and the lower membrane, communicating with the inflatable chamber, selectively communicating with the outlet, and having
a communicating recess formed in the body between the mounting segment of the upper membrane and the top side of the lower membrane, between the outlet and the concaved segment of the upper membrane, communicating with the outlet, and selectively communicating with the inflatable chamber of the body;
a ventilating duct formed in the top side of the lower membrane, communicating with the inflatable chamber, and selectively communicating with the communicating recess;
a covering board securely mounted on the top side of the lower membrane to cover the ventilating duct, extended into the inflatable chamber, extended toward the outlet, and having
an inlet hole formed through the covering board and communicating with the inflatable chamber and the ventilating duct; and
an outlet hole formed through the covering board, disposed below the communicating recess, and communicating with the ventilating duct; and
a valve slice disposed in the communicating recess, mounted on the covering board to selectively cover the outlet hole of the covering board, and having
a fixed edge securely connected to the covering board adjacent to the outlet; and
a free edge extended across the outlet hole and movably abutted on the covering board.

2. The aerating bag as claimed in claim 1, wherein the unidirectional nozzle has a holding mount mounted in the communicating recess and abutted on the valve slice.

3. The aerating bag as claimed in claim 1, wherein the leaking valve has
an inner end mounted in the mounting segment, extended through the inclined wall and facing the top side of the lower membrane;
an outer end extended out of the mounting segment; and
a sealing ring mounted around the leaking valve between the inner end and the outer end of the leaking valve and abutted against the inclined wall of the mounting segment.

4. The aerating bag as claimed in claim 3, wherein the leaking device has
a pressing button connected to the outer end of the leaking valve and disposed out of the mounting segment of the upper membrane; and
an elastic element mounted around the leaking valve between the inclined wall and the pressing button to facilitate the sealing ring to abut against the inclined wall.

5. The aerating bag as claimed in claim 1, wherein the body has a check valve securely mounted on the bottom side of the lower membrane near the rear end of the lower membrane, the check valve extended into and communicating with the inflatable chamber.

6. The aerating bag as claimed in claim 2, wherein the body has a check valve securely mounted on the bottom side of the lower membrane near the rear end of the lower membrane, the check valve extended into and communicating with the inflatable chamber.

7. The aerating bag as claimed in claim 3, wherein the body has a check valve securely mounted on the bottom side of the lower membrane near the rear end of the lower membrane, the check valve extended into and communicating with the inflatable chamber.

8. The aerating bag as claimed in claim 4, wherein the body has a check valve securely mounted on the bottom side of the lower membrane near the rear end of the lower membrane, the check valve extended into and communicating with the inflatable chamber.

9. The aerating bag as claimed in claim 2, wherein the leaking valve has
an inner end mounted in the mounting segment, extended through the inclined wall and facing the top side of the lower membrane;
an outer end extended out of the mounting segment; and
a sealing ring mounted around the leaking valve between the inner end and the outer end of the leaking valve and abutted against the inclined wall of the mounting segment.

10. The aerating bag as claimed in claim 9, wherein the leaking device has
a pressing button connected to the outer end of the leaking valve and disposed out of the mounting segment of the upper membrane; and
an elastic element mounted around the leaking valve between the inclined wall and the pressing button to facilitate the sealing ring to abut against the inclined wall.

11. The aerating bag as claimed in claim 9, wherein the body has a check valve securely mounted on the bottom side of the lower membrane near the rear end of the lower membrane, the check valve extended into and communicating with the inflatable chamber.

12. The aerating bag as claimed in claim 10, wherein the body has a check valve securely mounted on the bottom side of the lower membrane near the rear end of the lower membrane, the check valve extended into and communicating with the inflatable chamber.
